(19) United States
(12) Patent Application Publication
(10) Pub. No.: US 2022/0297798 A1
(43) Pub. Date: Sep. 22, 2022

(54) ELECTRONIC DERAILLEUR

(71) Applicant: TIEN HSIN INDUSTRIES CO., LTD., TAICHUNG CITY (TW)

(72) Inventor: Meng-Hua CHIANG, TAICHUNG CITY (TW)

(21) Appl. No.: 17/203,317

(22) Filed: Mar. 16, 2021

(51) Int. Cl. B62M 25/08; B62M 9/122; B62J 43/30

(52) U.S. Cl. CPC B62M 25/08; B62M 9/122; B62J 43/30

(57) ABSTRACT

An electronic derailleur having an actuating part, an actuated part and a charging seat is provided. The actuating part has a casing, and a control board, a battery and a driver disposed in the casing. The control board is electrically connected to the battery and the driver. The actuated part is connected to one side surface of the actuating part and linked with the driver. The charging seat is arranged on an external surface of the actuating part. The charging seat has a first portion and a second portion connected to the first portion. The first portion is provided with a first electrode electrically connected to the control board. The second portion is provided with a second electrode electrically connected to the control board. The charging seat is provided with a magnetic holder. The first portion and the second portion are asymmetrical in structure for positioning a charger connector.

### BACKGROUND

### Technical Field

This disclosure is related to an electronic derailleur, and in particular to an electronic derailleur of magnetic attraction charging type.

### Description of Related Art

A related electronic derailleur of bicycle has a battery to supply power for actuation thereof, and the arrangement has the type of a detachable battery and the type of a fixed battery disposed on a bicycle frame. The detachable battery needs to be detached for charging. However, the bicycle frame and the derailleur have other elements, and the other elements may hinder a user to detach the battery and therefore the detachment of battery is inconvenient. The fixed battery is charged by plugging a connector disposed thereon with a charging cable, but the connector has a risk of seepage and the connector may be wearing after frequent usage.

In views of this, in order to solve the above disadvantage, the inventor studied related technology and provided a reasonable and effective solution in this disclosure.

### SUMMARY

An electronic derailleur of magnetic attraction charging is provided in this disclosure.

An electronic derailleur having an actuating part, an actuated part and a charging seat is provided in this disclosure. The actuating part has a casing, and a control board, a battery and a driver therein disposed in the casing. The control board is electrically connected to the battery and the driver. The actuated part is connected to one side surface of the actuating part and linked with the driver. The charging seat is arranged on an external surface of the actuating part. The charging seat has a first portion and the rest portion is a second portion connected to the first portion. The first portion is provided with a first electrode electrically connected to the control board. The second portion is provided with a second electrode electrically connected to the control board. The charging seat is provided with a magnetic holder. The first portion and the second portion are asymmetrical in structure.

The electronic derailleur of this disclosure further has a charger connector coupled with the charging seat. The charger connector is provided with a first conductive point corresponding to the first electrode, a second conductive point corresponding to the second electrode and an attraction part corresponding to the magnetic holder. The charger connector is matched with the charging seat in shape.

According to the electronic derailleur of this disclosure, the charging seat is disposed on another side surface of the actuating part adjacent to the actuated part.

According to the electronic derailleur of this disclosure, the charging seat is disposed on another side surface of the actuating part nonadjacent to the actuated part.

According to the electronic derailleur of this disclosure, the charging seat is provided with a first positioning mortise structure. The first positioning mortise structure is disposed on one of the first portion and the second portion. The charger connector is provided with a second positioning mortise structure. The first positioning mortise structure is mortised with the second positioning mortise structure. The first electrode and the second electrode are different in shape, the first conductive point and the second conductive point are respectively matched with the first electrode and the second electrode in shape.

According to the electronic derailleur of this disclosure, the magnetic holder is disposed on a junction between the first portion and the second portion.

According to the electronic derailleur of this disclosure, the magnetic holder is disposed on one of the first portion and the second portion. The charging seat is provided with a positioning magnetic holder. The positioning magnetic holder and the attraction part are homopolar. The charger connector is provided with a positioning attraction part, and the magnetic holder and the positioning attraction part are homopolar.

According to the electronic derailleur of this disclosure, a coupling direction of the charger connector may be positioned by the asymmetrical structure of the charging seat, thereby the damage to the control board caused by the misconnecting of the first electrode and the second electrode with respect to the first conductive point and second conductive point may be prevented.

### BRIEF DESCRIPTION OF THE DRAWINGS

FIGS. 1 and 2 are perspective views showing an electronic derailleur according to an embodiment of this disclosure.

FIGS. 3 to 8 are perspective views showing various asymmetric structures of the electronic derailleur according to the aforementioned embodiment of this disclosure.

FIGS. 9 and 10 are perspective views showing an electronic derailleur according to another embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

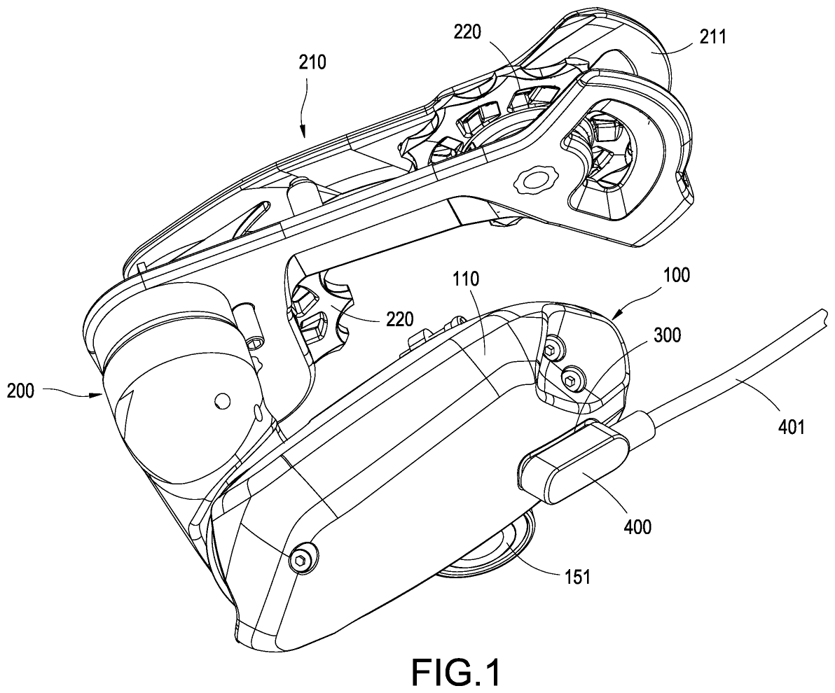

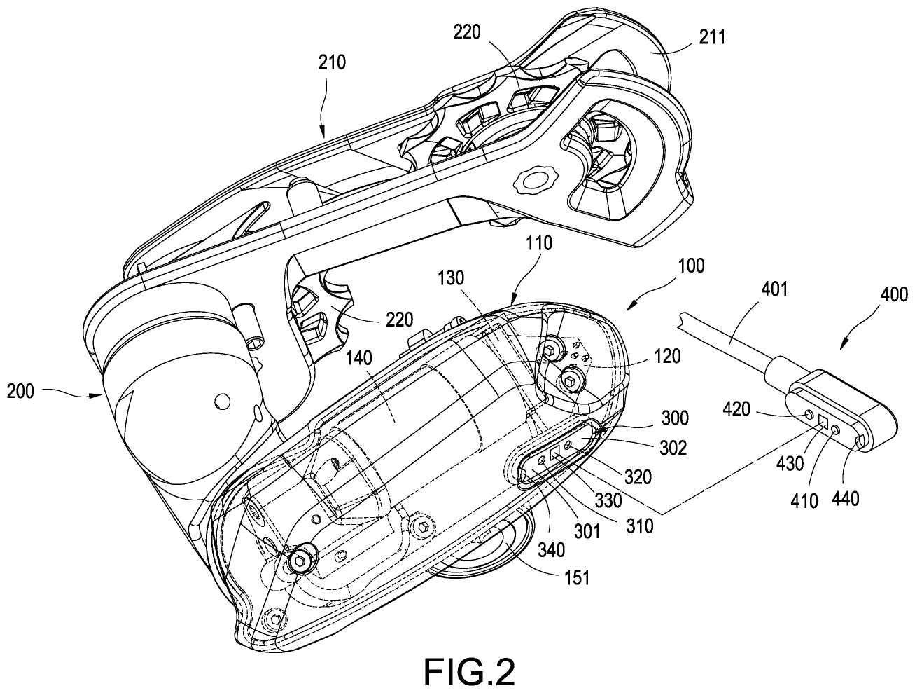

According to an embodiment of an electronic derailleur of this disclosure shown in FIGS. 1 to 3, the electronic derailleur at least has an actuating part 100, an actuated part 200, a charging seat 300 and a magnetic holder 330. According to this embodiment, the electronic derailleur further has a charger connector 400 for coupling with the charging seat 300.

The actuating part 100 has a casing 110, and a control board 120, a battery 130 and a driver 140 disposed in the casing 110. According to this embodiment, the driver 140 may be a motor, or alternatively may be any device capable of outputting kinetic energy such as a solenoid valve. The control board 120 is electrically connected to the battery 130 and driver 140. According to this embodiment, a rear derailleur is taken as an example, a fastening piece 151 is arranged on a side of the actuating part 100 for fastening the rear derailleur on a bicycle frame corresponding to the positions of freewheels or cassettes.

The actuated part 200 is connected to one side surface of the actuating part 100 and linked with the driver 140 via a gear box 141. According to the example of rear derailleur recited in this embodiment, the actuated part 200 has a chain shifting arm 210. The chain shifting arm 210 has a frame portion 211 for a chain to pass through. At least one pulley 220 is arranged in the frame portion 211 of the chain shifting arm 210 for the chain being winded thereon. In this embodiment, two pulleys 220 are disposed. The driver 140 drives the actuated part 200 to move the frame portion 211, thereby the chain may be shifted to engage with the selected gear in the freewheel.

According to design requirement, the charging seat 300 may be arranged on another side surface adjacent or opposite to the side surface where the actuating part 100 is located and exposed on an external surface of the actuating part 100. According to this embodiment, the charging seat 300 is disposed on another side surface adjacent to the actuated part 200. The charging seat 300 has a first portion 301, and the rest part of the charging seat 300 is a second portion 302 connected with the first portion 301 along a borderline. The first portion 301 and the second portion 302 are not limited to exact half parts of the charging seat 300. The first portion 301 is provided with a first electrode 310 electrically connected to the control board 120, and the second portion 302 is provided with a second electrode 320 electrically connected to the control board 120. Furthermore, a magnetic holder 330 is arranged on the charging eat 300, and the first portion 301 and the second portion 302 are asymmetrical in structure.

The charger connector 400 is provided with a first conductive point 410 corresponding to the first electrode 310, a second conductive point 420 corresponding to the second electrode 320 and an attraction part 430 corresponding to the magnetic holder 330. The charger connector 400 is matched with the charging seat 300 in shape. Specifically, one of the magnetic holder 330 and the corresponding attraction part 430 thereof is a magnetic element such as a magnet, another one of that may be a heteropolar magnetic element or a magnetically attractable material such as iron. When the charger connector 400 is coupled with the charging seat 300, the magnetic holder 330 and attraction part 430 attract each other and thereby the charger connector 400 is attached to the charging seat 300. Moreover, the first electrode 310 is coupled and electrically connected with the first conductive point 410, and the second electrode 320 is coupled and electrically connected with the second conductive point 420. A cable 401 is extended from a side of the charger connector 400, and the cable 401 is disposed on a position outside an action range of the actuated part 200.

According to this embodiment, the asymmetrical structure of the first portion 301 and the second portion 302 are specifically described in following paragraphs.

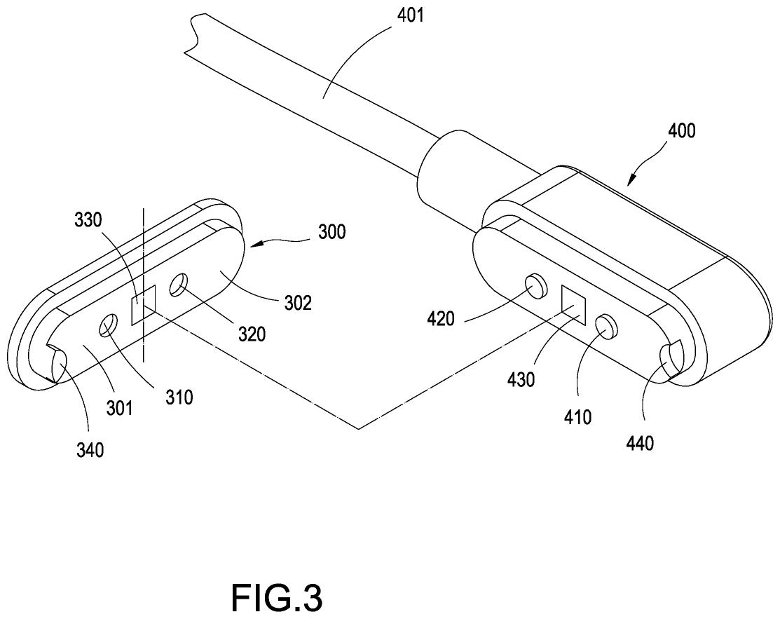

According to an asymmetrical structure showing FIG. 3, the charging seat 300 is provided with a first positioning mortise structure 340. The first positioning mortise structure 340 is disposed on one of the first portion 301 and the second portion 302, and the charger connector 400 is provided with a second positioning mortise structure 440. The first positioning mortise structure 340 and second positioning mortise structure 440 may be exchangeable mortise and tenon mortised with each other. The magnetic holder 330 is disposed centrally (midway) on a junction between the first portion 301 and the second portion 302.

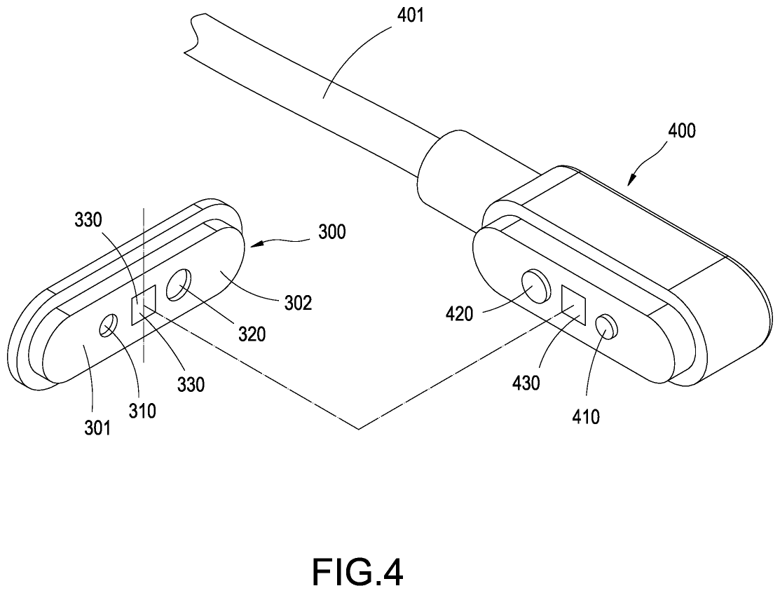

According to another asymmetrical structure showing FIG. 4, the first electrode 310 and the second electrode 320 are different in shape, and the first conductive point 410 and the second conductive point 420 are respectively matched with the first electrode 310 and the second electrode 320 in shape. Moreover, the first electrode 310 and the first conductive point 410 may be exchangeable mortise and tenon mortised with each other for positioning a coupling position. The arrangement of the second electrode 320 and the second conductive point 420 are similar with the first electrode 310 and the first conductive point 410.

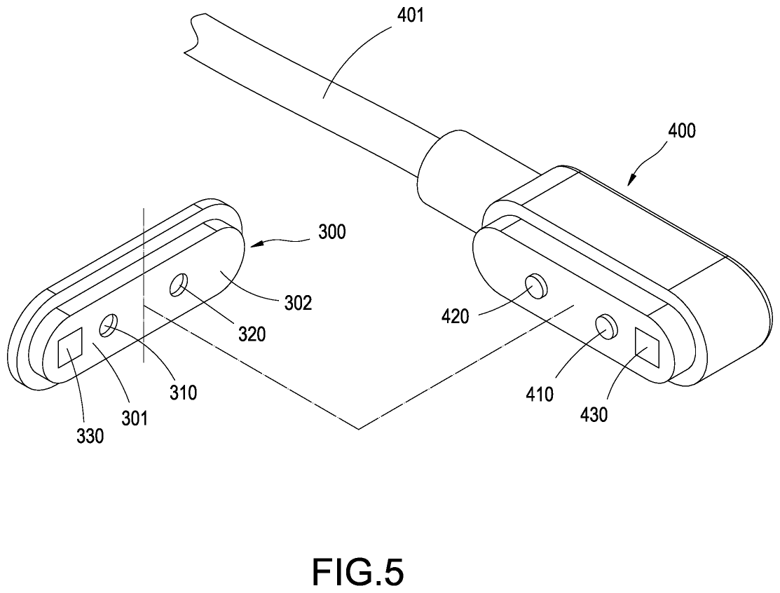

In addition to the aforementioned asymmetrical structure, a magnetically asymmetrical structure may also be adapted. According to FIGS. 5 to 8, an additional positioning magnetic holder 330a or positioning attraction part 430a may be used for positioning a coupling direction of the charger connector 400.

A magnetically asymmetrical structure is illustrated in FIG. 5. Referring to FIG. 5, the first electrode 310 and the first conductive point 410 may be exchangeable mortise and tenon mortised with each other for positioning a coupling position, and the arrangement of the second electrode 320 and the second conductive point 420 are similar with the first electrode 310 and the first conductive point 410. The first electrode 310 and the second electrode 320 may be identical in shape and respectively mortised with the first conductive point 410 and the second conductive point 420. The magnetic holder 330 is disposed on one of the first portion 301 and the second portion 302. Therefore, when the charger connector 400 is coupled with the charging seat 300 in a reversed direction, the magnetic holder 330 and the attraction part 430 cannot attract each other and thereby the charger connector 400 is loosened.

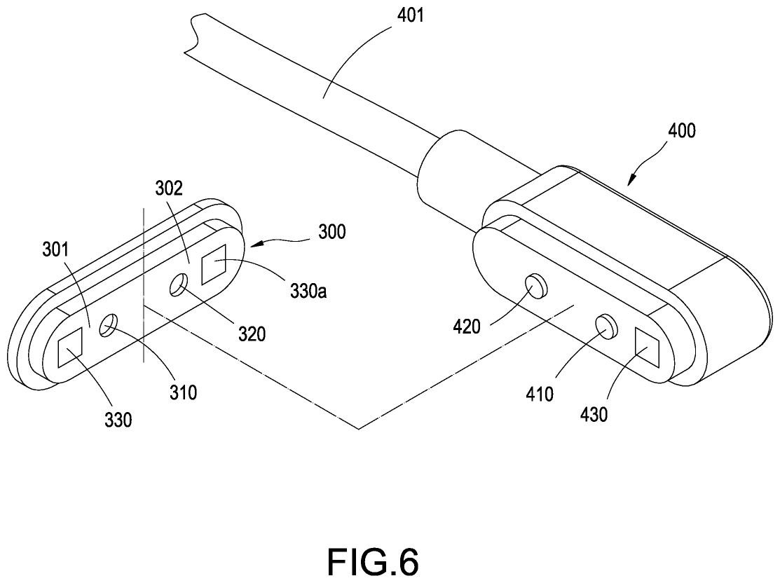

Another magnetically asymmetrical structure is illustrated in FIG. 6. Referring to FIG. 6, the first electrode 310 and the first conductive point 410 may be exchangeable mortise and tenon mortised with each other for positioning a coupling position, and the arrangement of the second electrode 320 and the second conductive point 420 are similar with the first electrode 310 and the first conductive point 410. The first electrode 310 and the second electrode 320 may be identical in shaped and respectively mortised with the first conductive point 410 and the second conductive point 420. A positioning magnetic holder 330a is arranged on the charging seat 300, the positioning magnetic holder 330a and the attraction part 430 are homopolar. Therefore, when the charger connector 400 is coupled with the charging seat 300 in a reversed direction, the positioning magnetic holder 330a and the attraction part 430 are close and repulsive to each other to loosen the charger connector 400.

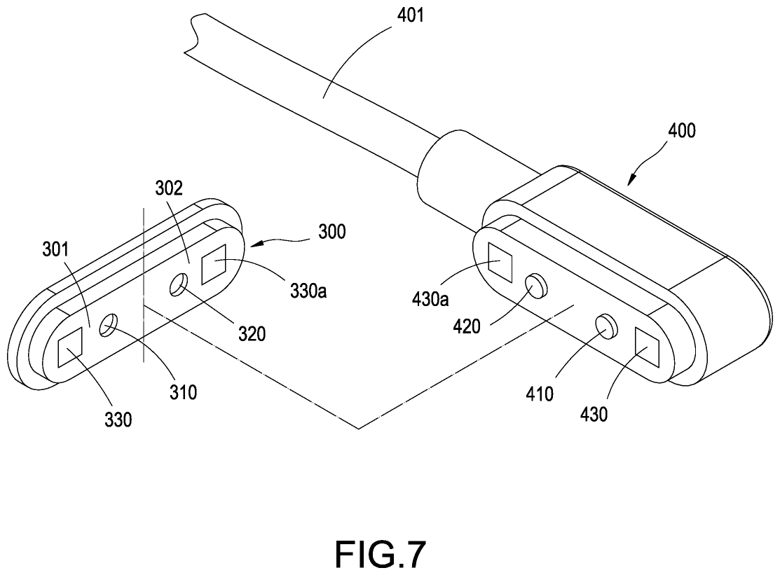

Further referring to FIG. 7, the charger connector 400 may be further provided with a positioning attraction part 430a corresponding to the positioning magnetic holder 330a. Specifically, one of the positioning magnetic holder 330a and the corresponding positioning attraction part 430a thereof is a magnetic element such as magnet, another one may be a heteropolar element or an iron piece. When the charger connector 400 is coupled with the charging seat 300, the positioning magnetic holder 330a and the positioning attraction part 430a may magnetically attract each other.

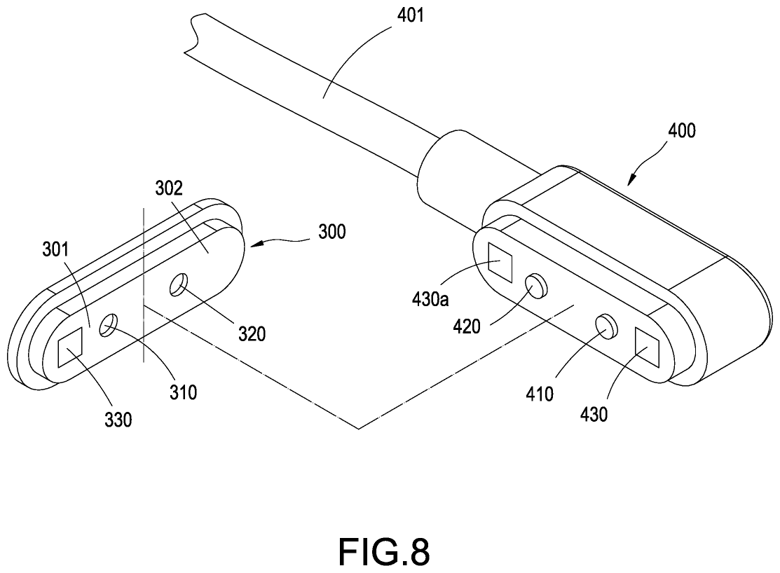

Further another magnetically asymmetrical structure is illustrated in FIG. 8. referring to FIG. 8, the first electrode 310 and the first conductive point 410 may be exchangeable mortise and tenon mortised with each other for positioning a coupling position, and the arrangement of the second electrode 320 and the second conductive point 420 are similar with the first electrode 310 and the first conductive point 410. The first electrode 310 and the second electrode 320 may be identical in shape and the first conductive point 410 and the second conductive point 420 are mortised with each other. The charger connector 400 is provided with a positioning attraction part 430a, the magnetic holder 330 and the positioning attraction part 430a are homopolar. Therefore, when the charger connector 400 is coupled with the charging seat 300 in a reversed direction, the magnetic holder 330 and the positioning attraction part 430a are close and repulsive to each other to loosen the charger connector 400.

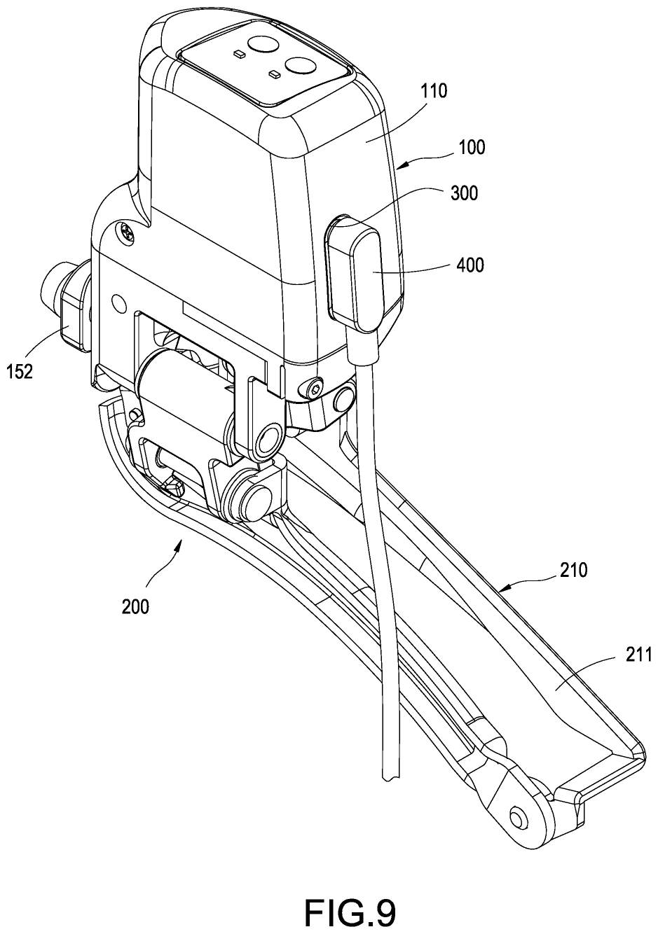

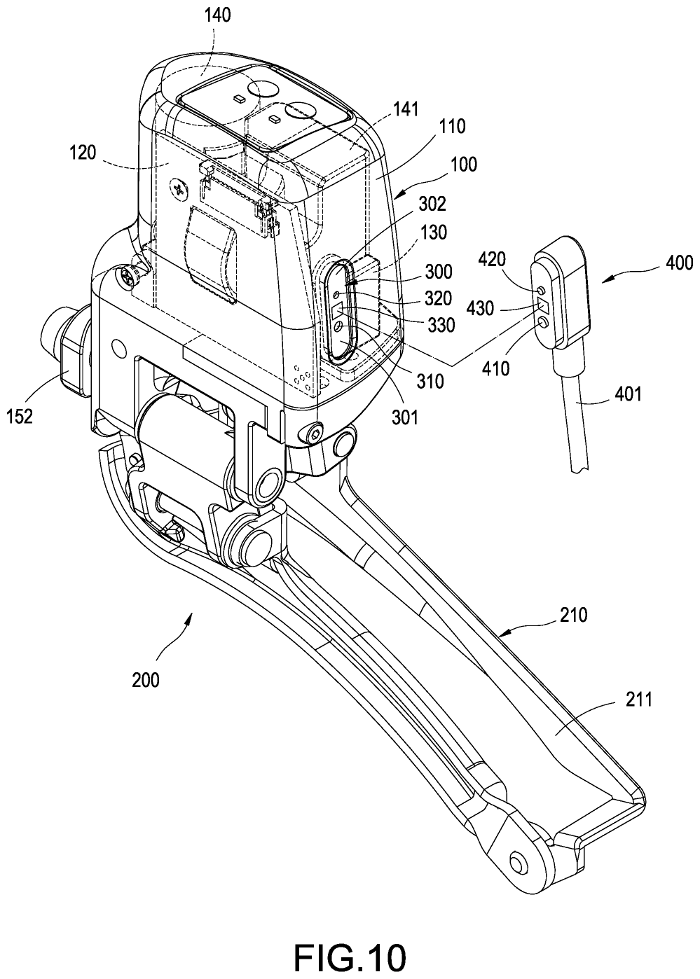

According to an electronic derailleur of another embodiment of this disclosure shown in FIGS. 9 to 10, the electronic derailleur at least has an actuating part 100, an actuated part 200, a charging seat 300 and a magnetic holder 330. According to this embodiment, the electronic derailleur of this disclosure further has a charger connector 400 for coupling with the charging seat 300, a cable 401 is extended from a side of the charger connector 400.

The actuating part 100 has a casing 110 and a control board 120, a battery 130 and a driver 140 arranged in the casing 110. According to this embodiment, the driver 140 may be a motor, or alternatively may be any device capable of outputting kinetic energy such as a solenoid valve. The control board 120 is electrically connected to the battery 130 and driver 140. According to this embodiment, a front derailleur is taken as an example, a fastening piece 152 is arranged on a side of the actuating part 100 for fastening the front derailleur on a seat tube of the bicycle frame corresponding to the positions of chainrings or chainwheels.

The actuated part 200 is connected to one side surface of the actuating part 100 and linked with the driver 140 via a gear box 141. According to the example of front derailleur recited in this embodiment, the actuated part 200 has a chain shifting arm 210, the chain shifting arm 210 has a frame portion 211 for a chain to pass through. The driver 140 drives the actuated part 200 to move the frame portion 211, and thereby the chain may be shifted to engage with the selected chainwheel.

The charging seat 300 is disposed on another side surface of the actuating part 100 different from the side surface on which the actuated part 200 is disposed and exposed on an external surface of the actuating part 100. According to this embodiment, the charging seat 300 is disposed on another side surface opposite to the actuated part 200. The charging seat 300 has a first portion 301, and the rest part of the charging seat 300 is a second portion 302 connected with the first portion 301 along a borderline. The first portion 301 is provided with a first electrode 310 electrically connected to the control board 120, and the second portion 302 is provided with a second electrode 320 electrically connected to the control board 120. Furthermore, a magnetic holder 330 is arranged on the charging eat 300, and the first portion 301 and the second portion 302 are asymmetrical in structure.

The charger connector 400 is provided with a first conductive point 410 corresponding to the first electrode 310, a second conductive point 420 corresponding to the second electrode 320 and an attraction part 430 corresponding to the magnetic holder 330. The charger connector 400 is matched with the charging seat 300 in shape. The cable 401 is disposed on a position outside an action range of the actuated part 200.

According to this embodiment, the asymmetrical structure of the first portion 301 and the second portion 302 are the same as the aforementioned embodiment.

According to the electronic derailleur of this disclosure, the charger connector 400 is magnetically attracted on the charging seat 300 and thereby the first electrode 310 and the second electrode 320 are respectively coupled with the first conductive point 410 and the second conductive point 420 for charging. This disclosure is convenient to operate, and it is not necessary to disposed a hole on the casing 110 and therefore the actuating part 100 is waterproof.

Furthermore, the coupling direction of the charger connector 400 is positioned via the asymmetrical structure of the charging seat 300, and thereby the damage to the control board 120 caused by the misconnecting of the first electrode 310 and the second electrode 320 with respect to the first conductive point 410 and the second conductive point 420 is prevented.

While this disclosure has been described by means of specific embodiments, numerous modifications and variations may be made thereto by those skilled in the art without departing from the scope and spirit of this disclosure set forth in the claims.

What is claimed is:

1. An electronic derailleur, comprising:
an actuating part, comprising a casing, and a control board, a battery and a driver disposed in the casing, and the control board electrically connected to the battery and the driver;
an actuated part, connected to one side surface of the actuating part and linked with the driver; and
a charging seat, arranged on an external surface of the actuating part, and comprising a first portion and a second portion connected to the first portion, a first electrode electrically connected to the control board and arranged on the first portion, a second electrode electrically connected to the control board and arranged on the second portion, wherein a magnetic holder is disposed on the charging seat, and the first portion and the second portion are asymmetrical in structure.

2. The electronic derailleur according to claim 1, further comprising: a charger connector, coupled with the charging seat, wherein a first conductive point corresponding to the first electrode, a second conductive point corresponding to the second electrode and an attraction part corresponding to the magnetic holder are disposed on the charger connector, and the charger connector is matched with the charging seat in shape.

3. The electronic derailleur according to claim 1, wherein the charging seat is disposed on another side surface of the actuating part adjacent to the actuated part.

4. The electronic derailleur according to claim 1, wherein the charging seat is disposed on another side surface of the actuating part nonadjacent to the actuated part.

5. The electronic derailleur according to claim 2, wherein a first positioning mortise structure is disposed on the charging seat, the first positioning mortise structure is disposed on one of the first portion and the second portion, a second positioning mortise structure is disposed on the charger connector, and the first positioning mortise structure is mortised with the second positioning mortise structure.

6. The electronic derailleur according to claim 2, wherein the first electrode and the second electrode are different in shape, the first conductive point and the second conductive point are respectively matched with the first electrode and the second electrode in shape.

7. The electronic derailleur according to claim 1, wherein the magnetic holder is disposed on a junction between the first portion and the second portion.

8. The electronic derailleur according to claim 1, wherein the magnetic holder is disposed on one of the first portion and the second portion.

9. The electronic derailleur according to claim 2, wherein a positioning magnetic holder is disposed on the charging seat, and the positioning magnetic holder and the attraction part are homopolar.

10. The electronic derailleur according to claim 9, wherein a positioning attraction part is disposed on the charger connector and magnetically attracts the positioning magnetic holder correspondingly.

11. The electronic derailleur according to claim 2, wherein a positioning attraction part is disposed on the charger connector, and the magnetic holder and the positioning attraction part are homopolar.
